(19) United States
(12) Patent Application Publication
(10) Pub. No.: US 2001/0045372 A1
(43) Pub. Date: Nov. 29, 2001

(54) COMPRESSIBLE PET PRODUCT APPARATUS AND METHOD

(76) Inventors: DENNIS M. CURLEY, BREA, CA (US); CHRIS M. BOOS, LOS ANGELES, CA (US)

Correspondence Address: SANTANGELO LAW OFFICES, 125 SOUTH HOWES THIRD FLOOR, FORT COLLINS, CO, 80521

(21) Appl. No.: 08/959,145

(22) Filed: Oct. 28, 1997

Related U.S. Application Data
(63) Continuation-in-part of application No. 08/493,913, filed on Jun. 23, 1995, now abandoned.
Application No. 08/493,913 is a division of application No. 08/255,483, filed on Jun. 8, 1994, now Pat. No. 5,445,275.

(51) Int. Cl. B65D 85/30; A01K 29/00; B65D 33/01; B65D 73/00; B65D 81/02

(52) U.S. Cl. 206/525; 206/523; 206/494; 119/28.5; 383/100

(57) ABSTRACT

A compressible pet product in a packaged system including both methods and specific types of packaging addresses the need for a fully recoverable, reduced-volume package. The system may involve initially folding the pet product and the like and wrapping the pet product for insertion into a bag or other flexible encasing. This bag may then be compressed externally or through evacuation. If the compression occurs through evacuation, the flexible encasing may act in conjunction with the ambient pressure environment to hold the pet product in a compressed state. An outer encasing may then be placed over the compressed pet product to hold it in a compressed state before releasing the compressed pet product to the ambient pressure environment. Alternatively, the compressed pet product may be compressed without an encasing such as through a mechanical compression element and extruded into an outer encasing. One or more foam pet products might be packaged in a single package in a manner which greatly reduces the volume necessary for inventory or shipping.

This application is a continuation-in-part of a pending application, Ser. No. 08/493,913, filed on Jun. 23, 1995 which is a continuation of the parent application, Ser. No. 08/255,483 which has issued as U.S. Pat. No. 5,445,275 on Aug. 29, 1995.

### BACKGROUND OF THE INVENTION

Generally, this invention relates to a compressible pet product and related packaging system for and techniques of compressing pet products in an economical manner and in a manner which may allow full recovery of the particular pet product compressed.

The desire to compress pet products for shipping and storage has been known outside the pet industry for many years. However, surprisingly, compression of pet products has simply not been realized in the pet industry prior to this invention. In a basic form, the concept involves taking an item such as a product substantially made of a compressible material (cellular material such as foam, fibrous material such as polyester fibers, and so forth) and compressing that item so that in either shipping or storage it consumes much less volume and is therefore less expensive and more economical to provide to the customer. Such a technique offers advantages throughout the distribution cycle. To the manufacturer, the distributor, and the retailer compressed products take up only a small fraction of the volume of the fully expanded product and thus allow more economical use of both inventory and retailing spaces. To the consumer, not only does the product consume less space in transportation, but it can also provide some degree of entertainment when the package is initially opened and the pet product becomes decompressed. It can also be very useful for storage after sale to the consumer who may wish to stock extra pet products for convenience. At the point of purchase, the consumer is not hindered by the compressed state of the particular item—and in fact may be reassured by it—since not only can they either see a picture of an actually decompressed pet product, but they may also find some comfort in knowing that the pet product has not been damaged, utilized, or exposed to dirt or germs prior to their purchase. While this basic concept seems quite simple, implementation is not so straightforward. To the contrary, simple compression in a practical manner which is economical for all those involved in the distribution cycle and which provides an untainted product to the consumer is attended by a great variety of challenges and problems.

Perhaps one of the most significant problems that those in some fields have faced is the fact that once compressed the pet product tends to want to decompress to its natural state. As a result a variety of efforts have been directed toward techniques which hold the item in the compressed state. Naturally, the greater the degree of compression, the greater the need for a restraining system.

At least two problems have presented themselves from the consumer's perspective which are solved by the present invention. First, from the consumer's perspective one of the most difficult problems for such pet products was the fact that when substantially compressed many items would either take too long to recover or would not fully recover. Although full recovery in a very short time frame—even after long storage—has been almost universally desired, until the present invention this goal was not practically achievable. This has been due in part to the fact that those involved in the compression of products did not understand that the particular material and process was important in determining recovery.

A second problem from the consumer's perspective has been the desire for the item to be easily removed from the container. Since the pet products inherently try to decompress, they tend to stick to any encasing. Again, the present invention solves this problem in a manner which meets consumer's desires.

As relating to the compression of products in general, certainly there are other problems which have arisen and which are solved by the present invention ranging from the need for a simple opening system to the need to be able to compress multiple products at one time and into one package. As discussed in other aspects of the specification and claims the present invention solves a host of different challenges in a manner which is both economical and acceptable to the consumer. As can be seen, many of these involve the proper combination of features to function together to achieve the desired result.

A key application of the present invention is that of the pet industry. A significant aspect of the pet industry includes the use of pet products made of compressible, flexible material for pet beds and the like. As to these pet products and this industry, prior to the present invention impediments to the distribution cycle included not only the space that such pet products occupy in shipping but also the space which they occupy in an inventory or retail setting. In spite of the fact that other industries have utilized techniques to minimize the amount of space required, the pet industry has not previously realized that these techniques were applicable to their industry in an economical manner. The previous efforts from unrelated fields simply were not recognized as being practically applicable by those in the pet industry. This is perhaps due in part to the fact that the pet industry is a very specialized field which caters to customers that have very different needs and desires from other consumers of compressible material products. As a result, rather than utilizing techniques available to other industries, those involved in the pet industry have focused their attention more on their own industry and its potentially unique requirements. As a result this one industry has overlooked solutions to long recognized problems even though some solutions may have been available from other fields. In this industry alone it can be seen that while those skilled in the art recognized the challenges of their high-volume products, they did not fully appreciate that the problem lay in a practical technique to compress the products during the distribution cycle and in a practical technique to allow them to be fully decompressed either in order to provide them to the consumer or after actually being purchased by the consumer.

As to both the pet industry and the overall desire to compress products, the present invention discloses techniques which overcome many of the previous problems in a practical fashion. Perhaps surprisingly, it satisfies a long-felt need to achieve economical and efficient compression of pet products for packaging through the implementation of techniques and elements that had long been available. To some degree, even those involved in the compression of products for packaging in other industries had not fully appreciated that the problems of sealing and recovery could be solved by either the proper selection of material or the utilization of the appropriate technique for compression. Obviously, substantial attempts had been made in order to solve the problems that those in various industries had faced in attempting to practically compress products. In spite of those attempts, until the present invention, the disclosed techniques and related system and apparatus were unrecognized by the pet industry, which has practically solved the spectrum of challenges which this seemingly simple task entailed.

### SUMMARY OF THE INVENTION

The present pet product invention includes a variety of aspects which may be selected in different combinations based upon the particular application or needs to be addressed. In one basic form, the invention discloses the use of a high quality compressible material, such as fibrous material or a foam material. In the preferred embodiment using foam, the foam may have a density of greater than 1.0 pounds per cubic foot to help assure full recovery. In another preferred embodiment using fibrous material such as polyester fiber, the use of hollow tubular fibers with a resiliency known as “loft” may be assistively activated by heat. This particular type of material has been found to not only achieve rapid recovery but also may achieve substantially full recovery even in instances in which the package has been maintained in a compressed state for a relatively long period of time. A second aspect of the invention is that it allows for a packaging system in which the compressed pet product is held in the compressed state with the assistance of an evacuation encasing if sealed, or if unsealed sometimes in conjunction with an outer encasing when compression has been achieved through the utilization of low pressures or evacuation. The invention also provides for a system in which low pressure or evacuation is achieved prior to compression of the pet product so that a seal on the encasing can be achieved prior to the “rumpling” which others had experienced. Another independent aspect of the invention is that it provides for a system in which both packaging and unpackaging are made simpler for those involved through the use of some type of intermediate wrapping. This wrapping can be achieved to make the product more sphere-like so as to allow maximum compression when accomplished through an evacuation or low-pressure technique. The invention also includes aspects such as the proper sizing of the bag and an opening element to facilitate the most efficient design. Finally, the inclusion of multiple compressed pet products in one package as well as the particular application to a unique industry—the pet industry—is included. Naturally, as a result of these several different and potentially independent aspects of the invention, the objects of the invention are quite varied.

One of the broad objects of the invention is to allow for a packaging system which is acceptable from the consumer's perspective. Thus one goal includes achieving maximum compression yet allowing immediate recovery of the pet product when opened. Further, beyond just quick recovery is also substantially total recovery. Thus, a goal is to allow substantially full recovery even when the pet product has been stored in a compressed state for a relatively long period of time. To achieve these, one goal is to provide for the selection of a peculiarly appropriate compressible material.

Another broad goal of the invention is to provide for packaging that consumes less volume than the total decompressed pet product. While this has obviously been achieved in other manners, a goal of the present invention is to achieve this in an economical and efficient manner which properly balances the interests of those involved in the distribution cycle and the interests of consumers. Thus one of the goals is to hold a collapsed or compressed product without unnecessary structure even when it has been compressed through evacuation.

In keeping with the prior goal of meeting the consumer's needs, it is a goal to provide a pet product packaging system which is both easily made and used. Thus one goal is to allow for maximum compression in an easy manner from the manufacturer's perspective. At the other end of the spectrum it is also a goal to allow for easy removal of the pet product by the consumer or the retailer. Each of these goals is met by providing a wrapping which both holds the pet product in the appropriate shape for insertion and allows easy removal from its encasing after it has been decompressed.

Yet another goal is to allow for efficient use of a compression packaging system in multiple products applications. This includes the goal of allowing for packaging of more than one pet product in one package as well as the goal of allowing for more than one package to be compressed and created in one manufacturing action.

Naturally further objects of the invention are disclosed throughout other areas of the specification and claims.

### BRIEF DESCRIPTION OF THE DRAWINGS

FIGS. 1A-C are drawings of a sequence of one pet product which has been compressed according to one embodiment of the invention. FIG. 1A shows the pet product decompressed. FIG. 1B shows the pet product initially compressed through folding and wrapping. FIG. 1C shows the pet product in a fully compressed state.

FIGS. 2A-C are drawings representing an exploded view of the components of a package prior to compression. FIG. 2A shows the pet product in an decompressed state; FIG. 2B shows a wrapping; FIG. 2C shows a bag encasing.

FIGS. 3A-C are drawings representing an exploded view a package showing multiple products prior to compression.

FIG. 4 is a drawing of a perspective view of a product such as that shown in FIG. 2a after it has been folded and wrapped according to one embodiment of the invention.

FIG. 5 is a drawing of one type of low pressure chamber which may be use in one embodiment of the invention.

FIG. 6 is a drawing of a perspective view of a package placed in the low pressure chamber prior to compression.

FIG. 7 is a drawing of a perspective view of a package about to be removed from the low pressure chamber after compression.

FIG. 8 is a view of a bag having one type of opening element pre-established along one edge.

FIG. 9 shows another embodiment of the reduced-volume compressed pet product being prepared for compression by initially folding the pet product.

FIG. 10 shows the embodiment of FIG. 9 being folded in a final form prior to compression.

FIG. 11 shows the final folded pet product being inserted into an encasing.

FIG. 12 shows the one embodiment of a compression element such as a vacuum pump with a vacuum nozzle.

FIG. 13 shows the bagged pet product being associated with the compression element.

FIG. 14 shows the compressed pet product in a reduced-volume state.

FIGS. 15-16 shows the compressed pet product being held in the reduced-volume state while an outer encasing is appropriated and placed over the compressed pet product.

FIG. 17 shows the compressed pet product encased by the outer encasing and the compressed pet product exposed to the ambient pressure environment.

### DETAILED DESCRIPTION OF THE PREFERRED EMBODIMENTS

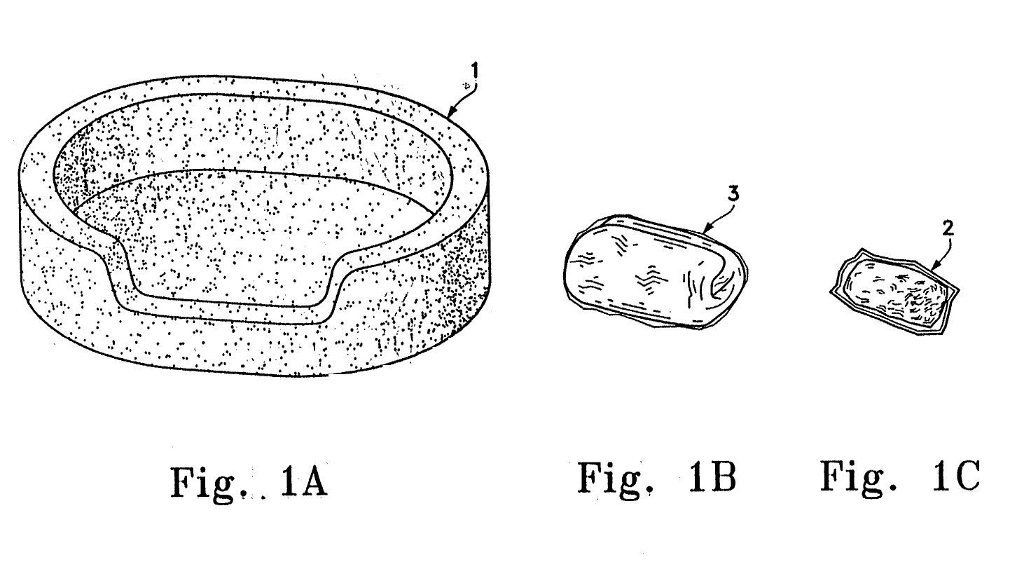

As mentioned earlier, the present invention includes a variety of aspects which may be combined in different ways regarding compressible pet products. The term compressible material or compressible pet products is meant to include any material for pet products which occupies a relative large volume compared to weight and can be readily compressed; it may include to a smaller percentage composition of generally less compressible items as the recycled products and even generally non compressible items (such as cedar chips) intermixed with the largely compressible material, for certain commercial enhancements. Each of these aspects is first discussed separately. As shown in FIGS. 1A-C, the invention involves providing a compressible pet product (1) and packaging it in a reduced volume manner so as to make a “fully” compressed pet product (2). As shown in FIG. 1B, this may be achieved through some intermediate step which creates an initially compressed pet product (3). With respect to compressible pet product (1), the pet product should be capable of being resiliently compressible, that is that it should achieve a reduced-volume state and yet resiliently be able to substantially recover to its original state. This recovery should not only occur quickly as discussed earlier, but it should be a complete recovery.

A surprising aspect of the present invention was discovered in ascertaining the appropriate type of material to use. From these efforts, it has been discovered that at least one seemingly unrelated characteristic can be used to assure that the compressible material meets the two goals of quick recovery and complete recovery. Prior art has not realized the importance of the proper material to achieve the objects of this invention. At least two possibilities are available. One is foam of a certain density which will resiliently resume its shape after decompression. Another type of material is a fibrous material. Such a fibrous material could be polyester, although the discussed principles below could apply to other fibrous materials, such as woven materials, natural and synthetic materials, and so forth. Heretofore, the use of polyester in the pet industry has not been developed relative to the compression objects of this invention and in this industry. It has been discovered that polyester is a suitable material that will achieve many of the present objects of this invention.

The grade of the polyester fibers influences the suitability of the material to be compressed and subsequently regain its shape. Polyester fibers are manufactured in the manner known to those experienced in the art. The process essentially involves the mixing of acids with petroleum products, pouring through a sieve, and cooling to produce virgin polyester fibers. Next, the fibers are “worked” back and forth. This process is known as “garnetting”. The fibers are then cut to a certain length for further processing. The length of the fibers appears to be sufficient if they are cut approximately one and one-half to two and one-half inches long, although other lengths might be eventually be preferable depending on economy and other considerations known to those in the art. A lower grade of polyester fibers are solid. It has been used with some success in compression using vacuum in the present invention. A higher grade of polyester fibers are hollow tubular fibers. While the use of higher density foam may satisfy the objects of this invention, the opposite appears to be true of polyester. The lower density of polyester through the hollow fibers allows more compression and yet still maintains resiliency (known as “loft”). An even higher grade of polyester is preferable to allow more compression and better resiliency. This higher grade polyester is manufactured by taking the polyester fibers and crimping the fibers into bent shapes such as the shape of the letter “Z”. This higher grade polyester has been found to be particularly suitable to accomplishing the objects of the present invention.

A key to the use of polyester, not known to be used in the pet industry to achieve the objects of this invention, is the heating of the fibers after decompression to restore the loft. From the manufacturing of the fibers, a “memory” shape is built into the fibers. This memory shape may be restored by heat. Thus, this material can be compressed, stored for a period of time, then released or decompressed and restored to its original shape by applying heat to the material after its decompression. More specifically, the material can be compressed in accordance with the teachings of this disclosure, decompressed, then placed in a common clothes dryer or other suitable and available heat source to resume its original shape, if desired or needed.

Specifically for the use of foam, it has been discovered that by specifically selecting material which will be compressed limited to open cell foam having a density greater than 1.0 pounds per cubic feet is satisfactory, quick and complete recovery can be almost assured. In this regard, the greater density selected, the better the recovery of the pet product. Densities of about 1.4 to 1.8 pounds per cubic foot lessen the amount of time of recovery. Further, it has been discovered that when the density is about 2.0 pounds per cubic foot, truly optimum results may be achieved.

Since there may be instances in which the density and/or quality of compressible material utilized may need to be varied for the particular application, each of the ranges are possible when compressing products according to this invention. The discovery that variation in density and/or quality coupled with heat actually can be used to determine the recovery of a compressed product is perhaps surprising for a number of reasons. First, while those involved in compressing pet products for packaging may have utilized a variety of materials, prior to the present invention they did not appreciate the impact that the control of density, nor the quality coupled with heat has on the ability of the pet product to recover from its compressed state. Further the selection of the product should be made specifically, not by accident, so that appropriate quality and customer satisfaction is assured.

Quality of the material is not the only characteristic which can impact recovery. It has also been discovered that the use of particular additives such as fire retardant can also have effects upon the ability of the pet product to recover from a compressed state. Again, perhaps surprisingly, it has been discovered that when fire retardant is added to a particular material, it may actually assist the product in its recovery and may allow it to be more appropriate as a compressed packaging material.

Besides simply compressing the raw material, other components related to the compressible pet products could be included in the compressed pet product package. For instance, a cover, such as a decorative cover, could be included either on or in the pet product package, compressed with the compressible pet product, and sold as a unit. Other inserts could be included such as a product bottom that typically could be placed into the bottom of a pet bed on which the pet could lie. Other products could be included with the compressible pet product that in themselves may be compressible or generally non-compressible. For instance, cedar chips may add attributes to the material that benefit the resistance to household pests, as well as add scent to area of the pet product. Likewise, various recycled goods could be added to the raw material which could include woven products, recycled foam products and so forth. Other materials could include flea retardants, whether chemical, mechanical, or otherwise, and could include boric acid as might exist in powder form. The percentages of inclusion of these materials of the various composition of materials would typically depend upon the commercial desires and commercial viability to be balanced against the goal and desire of offering a compressed pet product.

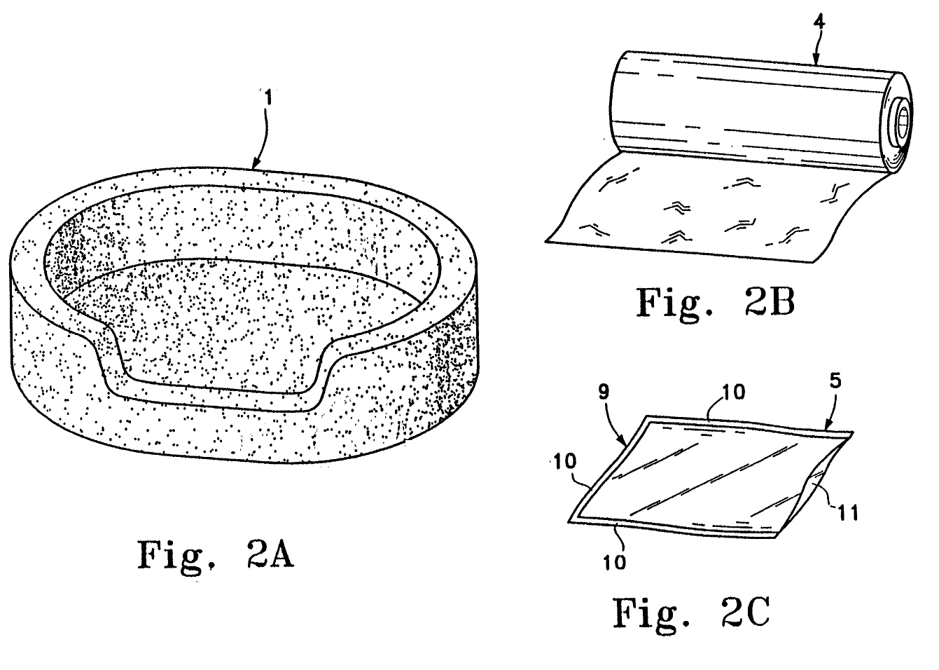

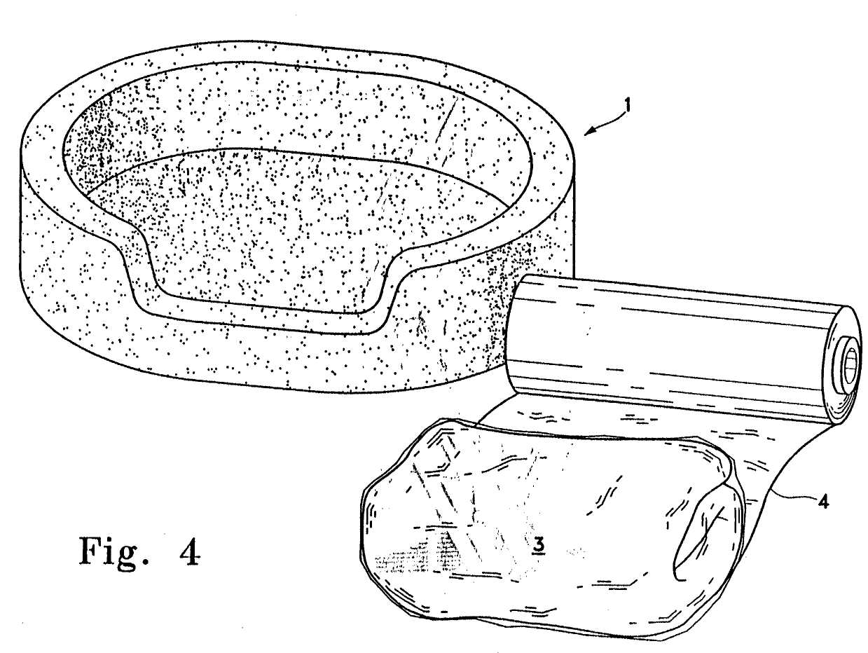

To achieve a compression according to the present invention the pet product may be compressed either through an external compression element or through some type of evacuation technique. External compression has been explained in several of the cited references. Referring to FIGS. 2A through 2C, one unique evacuation technique of the present invention can be easily understood. First, compressible pet product (1) may be initially compressed, such as by folding. This can occur mechanically, by hand, or when wrapping it in a flexible sheet-like material (4) as shown in FIG. 4. In achieving this wrapping, compressible pet product (1) may be folded so as to create initially compressed pet product (3). As shown in FIG. 4, this folding and wrapping may be done in such a manner so as to make compressible pet product (1) more spherical after it has been transformed into initially compressed pet product (3). As seen in FIG. 4 initially compressed pet product (3) is not completely spherical but rather just more spherical than the natural decompressed state of compressible pet product (1).

The step of initially compressing the pet product facilitates both manufacture and utilization. FIG. 4 shows the pet product folded to make it more spherical and wrapped with a flexible sheet-like material (4). This flexible sheet-like material (4) and wrapping may have several important properties. First as can be appreciated from FIG. (4), flexible sheet-like material (4) may be used to substantially encircle the pet product to be compressed.

Another property desirable for the wrapping is useful in the event it has been selected to initially compress compressible pet product (1). In such instances, it may be convenient to select flexible sheet-like material (4) from materials exhibiting the property of having high friction with respect to itself. Thus, like many cellophane wraps, flexible sheet-like material (4) can actually serve to hold compressible pet product (1) in its initially compressed state and facilitate other steps which are necessary to achieve full compression. By the term high friction, it is meant that flexible sheet-like material (4) might cling to itself sufficient enough so that the natural tendency of initially compressed pet product (3) might not be so strong so as to overcome the ability of flexible sheet-like material (4) to hold it in the desired state at least temporarily. This wrapping can thus serve as one way of serving to create and maintain the state of initially compressed pet product (3).

Referring to FIG. 2C, it can be understood that in order for the full compression to occur, the pet product may be substantially surrounded by a flexible encasing (5). It is flexible so that when compression occurs it can conform to the reduced-volume state created. In some embodiments, it may be substantially impermeable, so that once the pet product has been compressed it does not leak a significant amount and thus allow the external ambient pressure environment to leak into the package and allow it to decompress prematurely. In other embodiments not requiring leak considerations, the flexible encasing (5) may serve to allow temporary evacuation of ambient air so as to achieve the reduced-volume state, while an outer encasing, such as a sleeve, is placed over the reduced-volume pet product to hold in a compressed state when the pet product returns to a more ambient pressure environment. For these purposes, the flexible encasing (5) may be impermeable (other than the opening through which the vacuum is pulled or air evacuated) in the sense that the material will allow a sufficient evacuation to occur at least temporarily in the processing.

As should be easily appreciated, there are a great variety of devices and pet products which may serve as flexible encasing (5). While shown in FIG. 2C as essentially a bag, additionally two sheets which may ultimately be sealed together around their edges or other types of arrangements may be utilized. Once substantially surrounded by flexible encasing (5), compressible pet product (1) may be fully compressed. As can be easily appreciated, some heating element could seal the two flat sheets and thus create the entire encasing. The utilization of a bag (9) as mentioned later, however, allows for simplified manufacture.

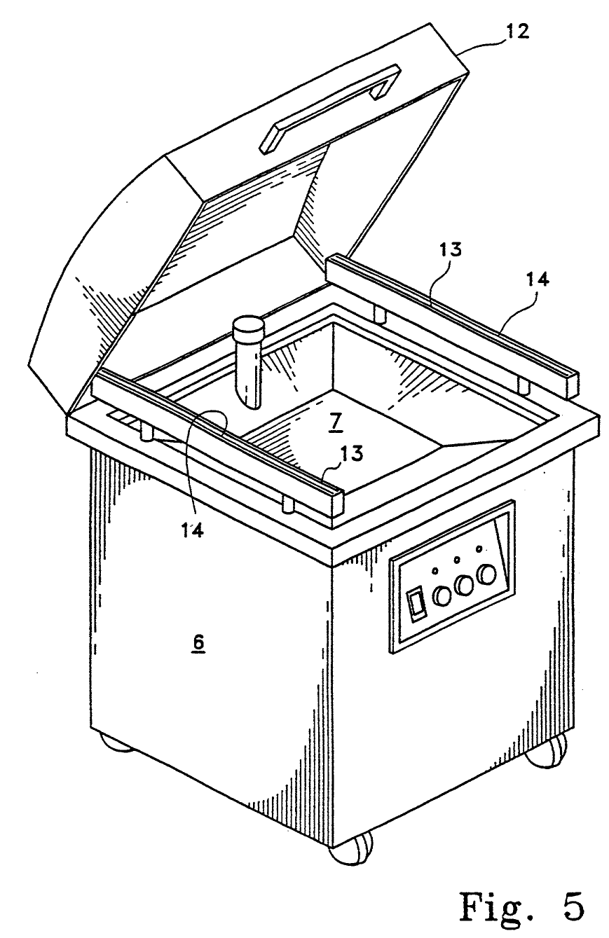

To fully compress the pet product in accordance with one embodiment of the invention, the pressure to which compressible pet product (1) is subjected may be reduced. Referring to FIGS. 5 and 6, one technique of achieving a reduction in volume can be understood. FIG. 5 shows low pressure chamber (6) into which the substantially surrounded pet product might be placed. As can be appreciated, low pressure chamber (6) should include some type of vacuum pump or other low pressure source so as to draw air from an area into which the pet product has been placed. As shown in FIG. 5, this area is chamber area (7).

In creating the package, either compressible pet product (1) or initially compressed pet product (3) may then be inserted into bag (9) through bag opening (11). With respect to inner wrapping (8) mentioned earlier, another property may be understood. Specifically, it may be desirable for inner wrapping (8) to be made of a material which exhibits low friction with respect to flexible encasing (5). By the term low friction, it is meant that flexible sheet-like material (4) might not stick to flexible encasing (5) when initially compressed pet product (3) is either inserted during the manufacturing process or removed by the consumer. As may be appreciated, this would allow easy and quick manufacture and opening and avoid any unnecessary need to completely rip open flexible encasing (5). Thus, inner wrapping (8) may be situated along the outer boundary surface of initially compressed pet product (3) between the pet product and flexible encasing (5). When selecting bag (9), as an pet product made from polyethylene nylon film, it has been found that by selecting inner wrapping (8) to be made from blown polyvinyl chloride film, not only is there high enough friction to hold inner wrapping (8) to itself, but also inner wrapping (8) exhibits low friction with respect to bag (9).

When utilizing bag (9) as the flexible encasing, it can be beneficial to size bag (9) so as to accommodate not substantially more than initially compressed pet product (3). Not only does this avoid any waste of material—and further provide for an economical packaging system, but it also offers advantages in the compression process itself. When the pet product becomes compressed, if it is held in place by an encasing which compresses with the pet product, that encasing will naturally wrinkle as it surrounds a lower volume. To minimize the amount of wrinkling and thus enhance compression (or at least minimize any negative effects from the bag), the pet product in one embodiment is initially compressed. Bag (9) is then selected so as to accommodate not substantially more than initially compressed pet product (3). The bag (9) (or the outer encasing described below) may be color coded or other indicia to indicate different pet products, different pet product sizes, and so forth. Additionally, the color coding may be useful to make the bag more pleasing to the consumer and obscure any commercially unfavorable appearance of the pet product in a compressed condition.

To achieve compression according to one embodiment, the encased pet product may be placed within chamber area (7) as shown in FIG. 6. Lid (12) of low pressure chamber (6) is then lowered to create some type of seal and the chamber is activated. Activation of low pressure chamber (6) causes pressure within chamber area (7) to be lowered to a predetermined level. This pressure may be selected based upon the amount of compression desired. In practice it appears that the amount of compression occurs very rapidly with initial pressure changes but then drops more slowly as lower and lower pressures are achieved. For this reason it may be appropriate to balance the time that it takes to achieve lower pressures with the amount of compression desired. For some products, it has been found that by operating low pressure chamber (6) at a level of about 100 psi for about 20 seconds, approximately 80% compression is achieved. Importantly, as may be appreciated, compression does not occur as the pressure chamber achieves lower pressure since the entire package is subjected to the same pressure. Thus the package remains in roughly only its initially compressed state as shown in FIG. 6 throughout the entire pressure reduction. This is advantageous because it avoids “rumpling” which had so plagued prior efforts and allows the package to be easily sealed.

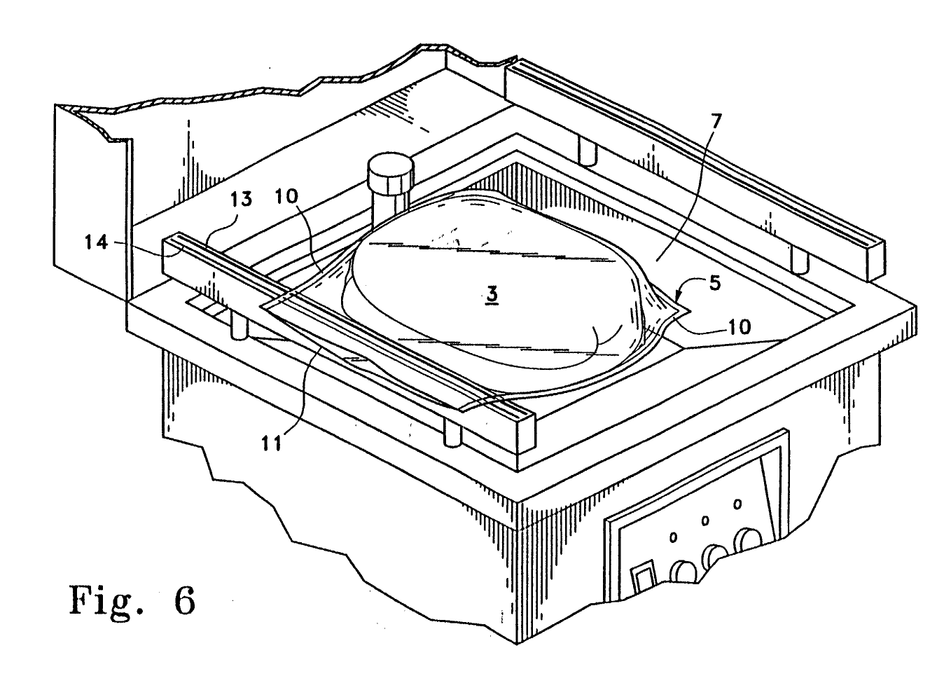

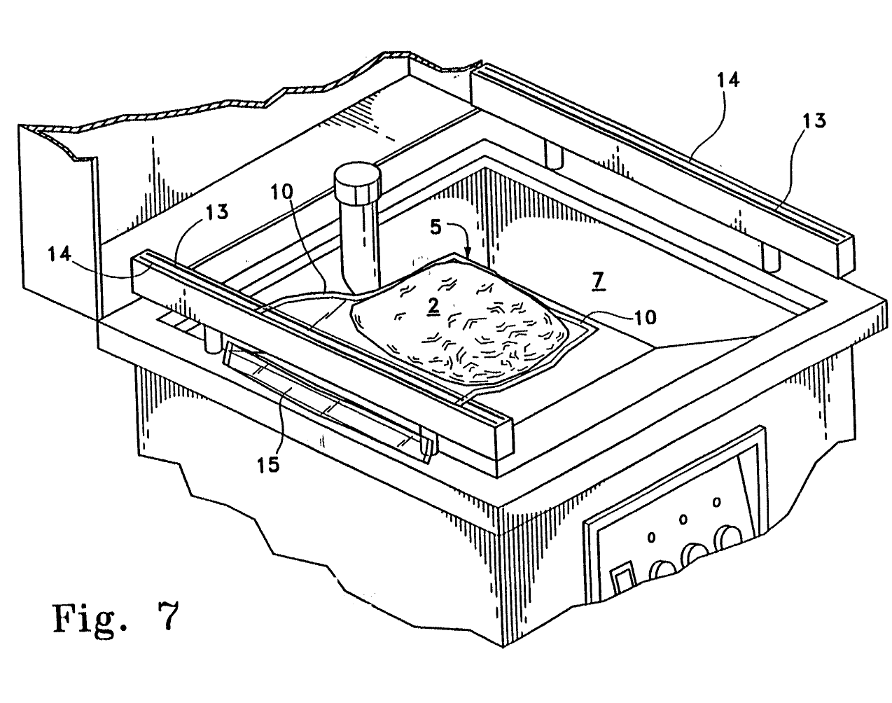

As shown in FIGS. 5, 6, and 7, low pressure chamber (6) may include both a sealing element (13) and a trimming element (14). These can be easily understood with reference to FIGS. 6 and 7. As shown in FIG. 6, flexible encasing (5) can be placed in chamber area (7) so that bag opening (11) is positioned to place bag (9) over both sealing element (13) and trimming element (14). By placing bag opening (11) within chamber area (7), air within flexible encasing (5) will exit through bag opening as the pressure within chamber area (7) is reduced. Since the exterior of flexible encasing (5) is also subjected to these reduced pressures, compression does not yet occur. Rather, flexible encasing (5) remains in roughly the same position as shown in FIG. 6. This can be assured by clamping the pet product within chamber area prior to and during the sealing process as well to avoid any possibility of folds in the area to be sealed.

Through proper cycling of low pressure chamber (6), sealing element (13) can be activated. This occurs by operating in conjunction with heating elements contained within lid (12) in this particular apparatus. Through timing, flexible encasing (5) can be melted, bonded, ultrasonic sealed, or otherwise affected by sealing element (13) so as to create a seal of the flexible encasing (5). This newly created seal acts in conjunction with pre-established seals (10) so as to cause a completely sealed flexible encasing (5) for the pet product. Once this has been achieved, trimming element (14) may be activated so as to cut excess portion (15) of flexible encasing (5). Again, by utilizing heat for merely a longer period of time (or more intense heat) excess portion (15) can be completely severed from flexible encasing (5). This is shown in FIG. 7.

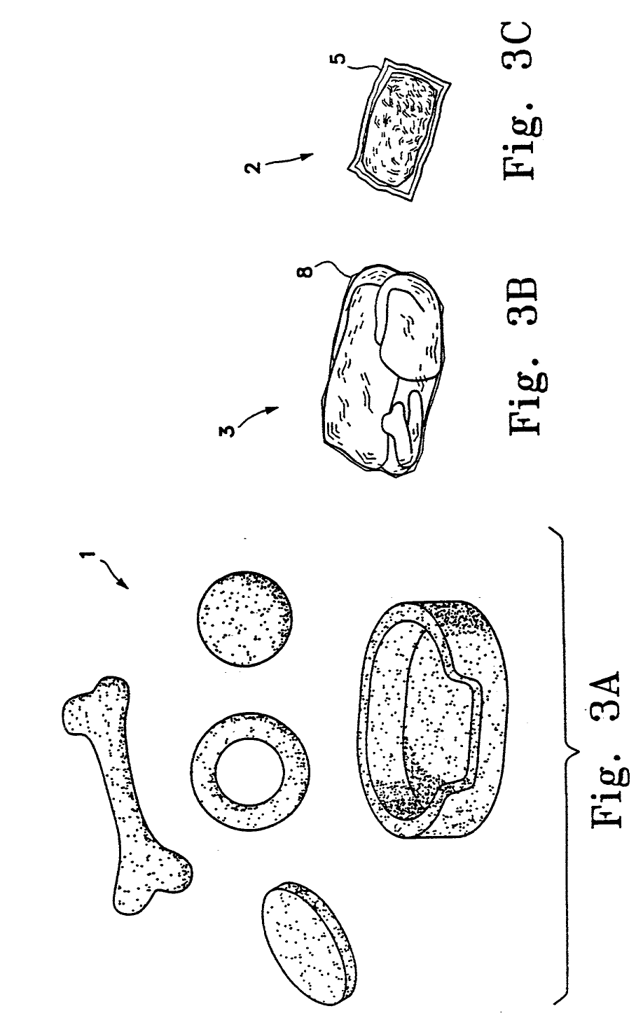

In this particular embodiment, once flexible encasing (5) has been sealed and the vacuum released, compression may occur. This may be achieved in this embodiment by exposing the compressible pet product encased in the encasing to ambient pressure. (Exposing in this context in meant to include exposing the compressible pet product encased in a sealed encasing at a reduced pressure to ambient pressure.) As this occurs, the compressible pet product is actually compressed and flexible encasing “rumples” in on itself. Since the pet product has already been sealed, however, this rumpling poses no problem. Also, since flexible encasing (5) may be substantially impermeable, in this embodiment, it acts to hold the pet product in a fully compressed state by interaction between the encasing and the ambient pressure environment. The pet product may then be removed from low pressure chamber (6) and the process begun on another pet product. As can be appreciated from the type of low pressure chamber (6) shown in FIGS. 6, 7, and 8, more than one sealing element (13) and trimming element (14) may be included. From utilizing this type of low pressure chamber (6), multiple pet products may be sealed at once by positioning them either next to each other or on opposite sides of chamber area (7). Similarly, multiple pet products may be compressed at once for a single package. Referring to FIGS. 3A-C (which are not shown to scale), it can be seen that a plurality of compressible products can be assembled, wrapped, and then all inserted into a single bag for single packaging similar to the process just described. In some instances, generally% non-compressible products may be included, in the package so as to offer the customer a more complete package, such as a cover for a pet bed, a bottom filler for the pet bed, and other products that could fit into a generally compressed pet product package.

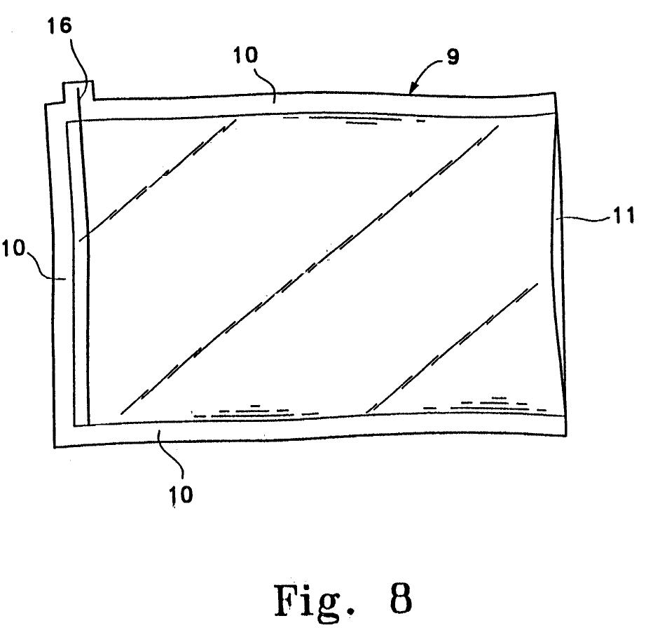

Once removed from low pressure chamber (6), fully compressed pet product (2) may then be further packaged such as in a box. This could allow the incorporation of some type of picture to show the decompressed pet product so that the consumer can understand the product which they are purchasing. Since the product is designed to be easily used by the consumer, bag (9) may include some type of opening element (16) as shown in FIG. 8. The opening element may be a weakened portion or alternatively some type of tab or string or any other of a variety of elements which may be disclosed in a host of different arts. Naturally, in one embodiment, such an opening element should not negatively impact impermeability if the encasing is made to be impermeable. For simplicity, as shown in FIG. 8, opening element (16) may be incorporated into bag (9) on one edge which has pre-established seal (10). This may be accomplished prior to substantially surrounding either compressible pet product (1) or initially compressed pet product (3) by insertion into bag (9). Thus the opening element may be integral to bag (9) and located along one of the edges. Again, this can be done through manufacture of bag (9) so that the actual packaging of compressible pet product (1) is not further complicated. Alternatively the particular sealing element (13) or other aspects of low pressure chamber (6) might be designed so as to allow simple opening by the consumer. Thus consumer may rip open flexible encasing (5) upon which fully compressed pet product (2) expands to an initially compressed state. Initially compressed pet product (3) may then be easily removed from bag (9) due to inner wrapping (8). It may then be unwrapped to its fully decompressed state so the consumer may then enjoy the pet product for its intended use and discard of bag (9) and inner wrapping (8). The pet product would thus be compressed upon packaging and remain that way through shipment, storage and other facets (collectively referred to as “shipment”) for ultimate enjoyment by the consumer. Alternatively, it would be possible to package pet products so that the retailer might open them and dispose of the encasing and display them in their decompressed state. This might be particularly advantageous when packaging more than one pet product in a single package.

Another embodiment described briefly above relates to a compressible pet product which is typically not sealed in its final form from the ambient pressure environment. This embodiment and the related steps are described in FIGS. 9 through 17. In the preferred embodiment of this type, a compressible pet product, such as is shown in FIG. 1A as compressible pet product (1), may be initially folded either by hand or through some device as an initially folded product (20). As shown in FIG. 9, the outside sections may be folded toward the middle of the pet product. Next, in FIG. 10, for further reduction of the compressible pet product prior to compression, the initially folded product (20) may be further folded, such as by rolling, or otherwise further reduced to a final folded product (21).

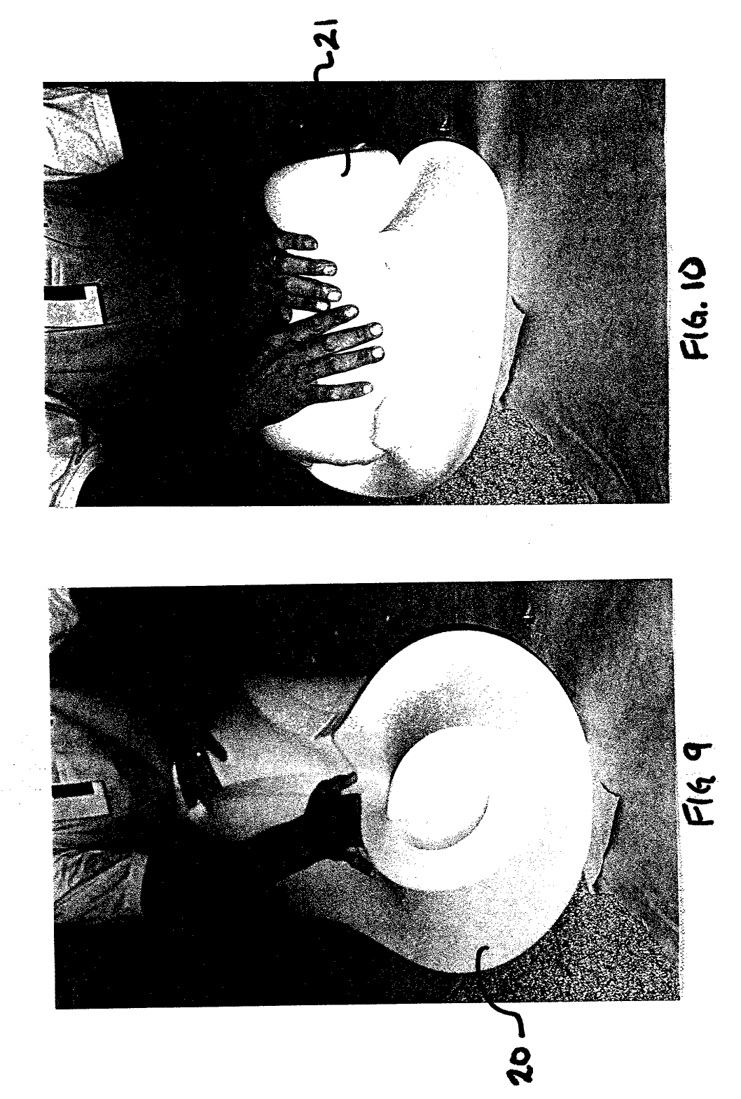

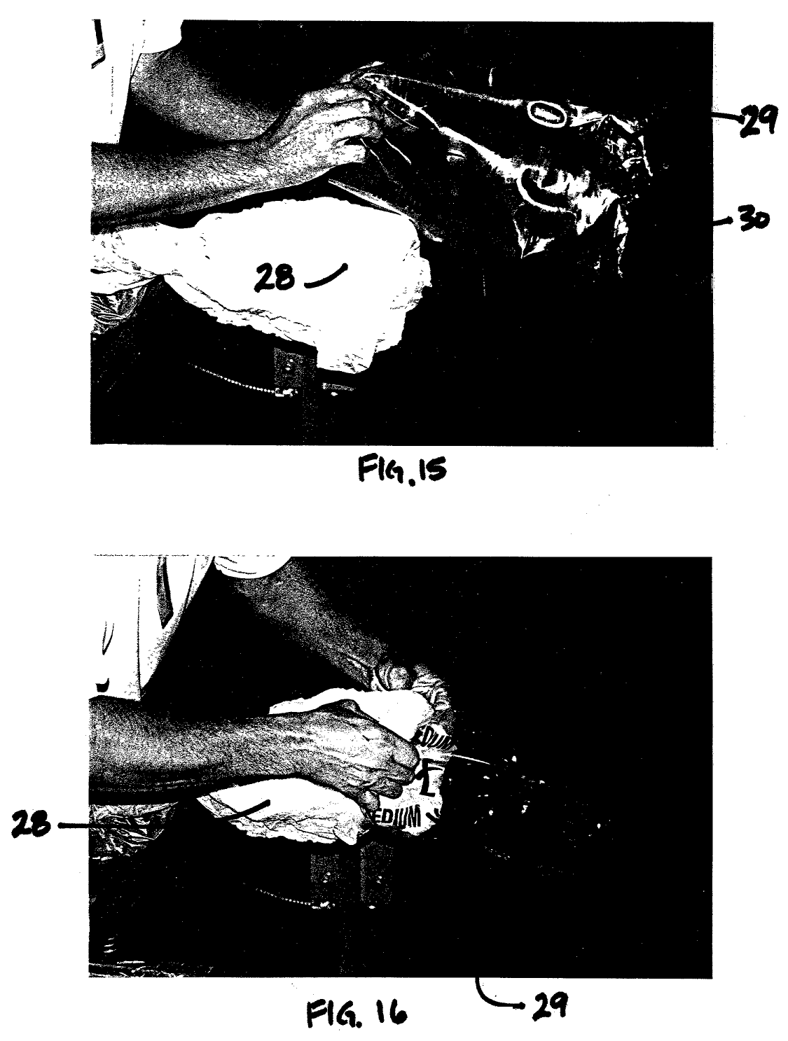

In FIG. 11, the final folded product (21) may be inserted into an evacuation encasing (22), which may be a bag, similar to the flexible encasing (5). The pet product, which may include the encasing, may be colored or color coded, translucent or opaque, as commercial issues such as packaging attractiveness, are considered. Additionally, various coloring schemes or other indicia may assist in identifying the particular pet product that is compressed in its final form. The evacuation encasing (22) may come pre-prepared and sealed about substantially all of the points other than an opening through which the final folded product (21) may be inserted. A next step in the preferred embodiment may involve associating the finally folded product (21) now encased in evacuation encasing (22) to a compression element. The compression described in this embodiment can be done by the evacuation of the fluid, typically air, from the compressed pet product. Naturally, the compression can be done by mechanical methods, including hydraulic methods. For instance, the compressible pet product could be compressed using a mechanical compression element (with or without the evacuation encasing (22)), then mechanically held in position or in compression, and then forced into an outer encasing, perhaps by a piston or other extrusion process. The outer encasing (29), shown in more detail in FIGS. 15-17, could be a sleeve, plastic tube, jar, cardboard tube, metal container, can, and so forth.

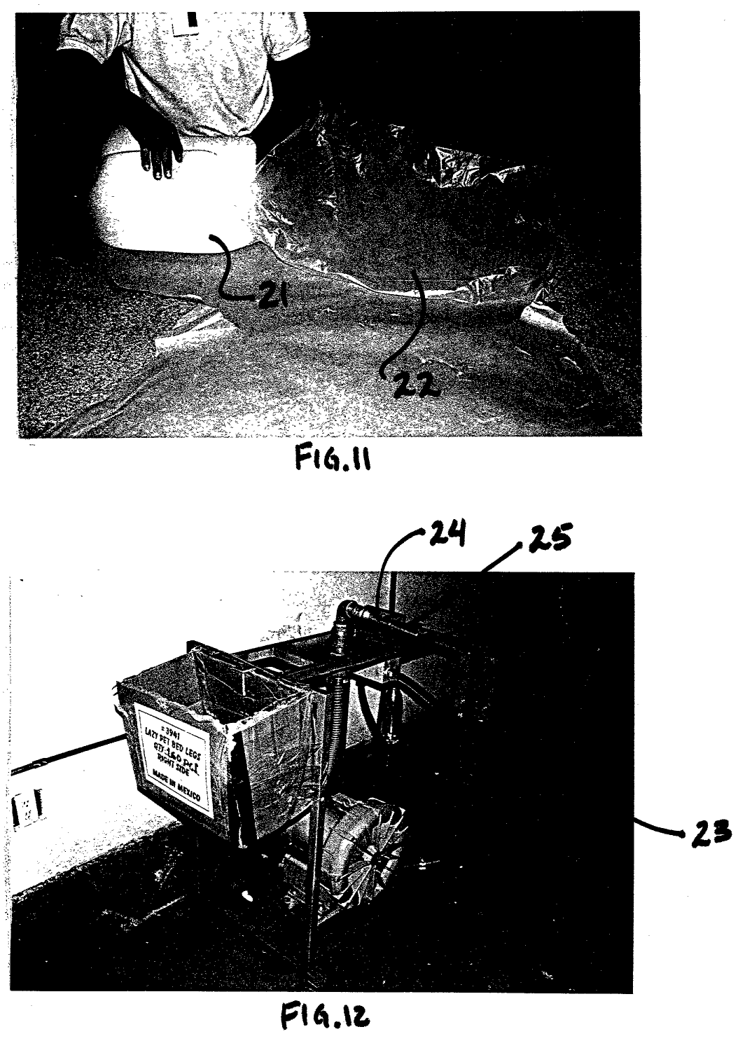

This compression element in the embodiment shown in FIG. 12 may be a vacuum pump (23), or other fluid evacuating device, and may have a vacuum nozzle (24). The vacuum nozzle (24) may be short or may be elongated. Some assistance has been noted by elongating the vacuum nozzle (24) and placing vacuum holes (25) at various locations throughout the nozzle. This is believed to assist in a more uniform evacuation of the air, or other fluid, from the final folded product (21).

FIG. 13 shows the bagged pet product (26) being inserted over the vacuum nozzle (24) at the opening (27) of the evacuation encasing (22). Naturally, other openings could be used, including simply puncturing a hole through the evacuation encasing (22).

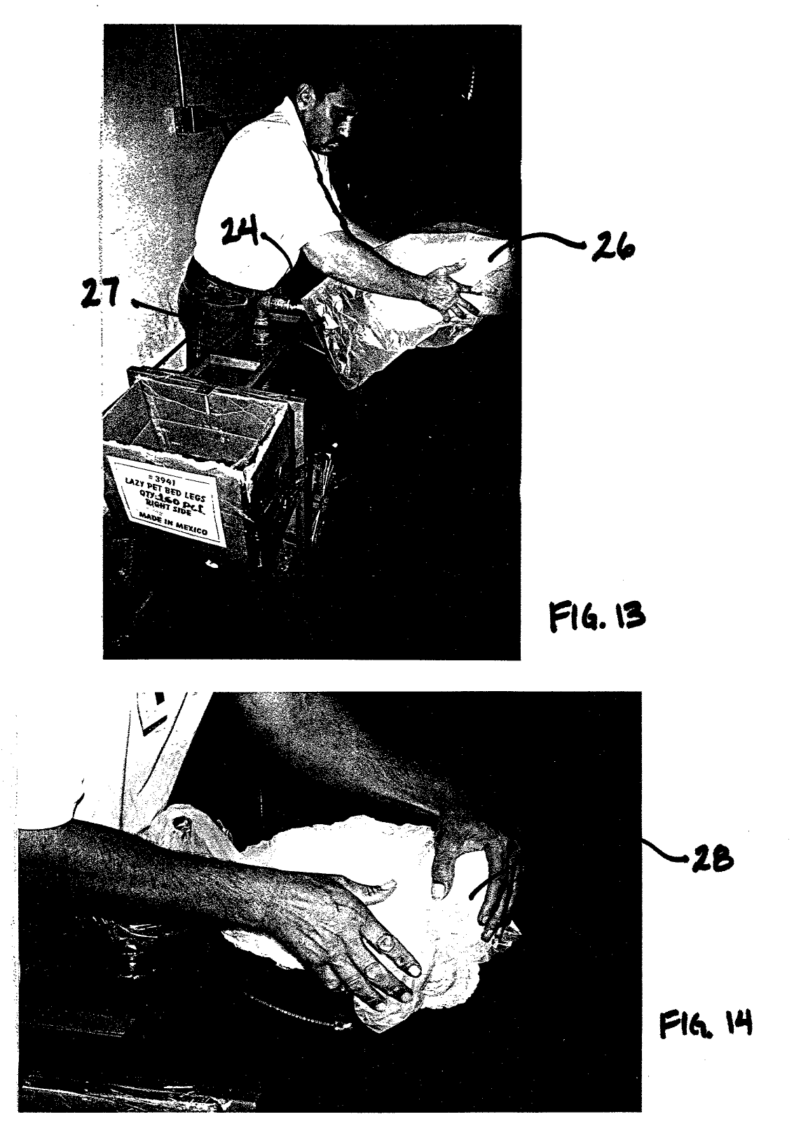

FIG. 14 shows the bagged pet product (26) as at least a partially compressed pet product (28) in a substantially reduced-volume state. The term substantially reduced-volume is meant to include more than simply hand folding and may be 50% compression or more (typically up to 80% compression) of the initial volume. The opening (27) of the evacuation encasing (22) has been sufficiently and at least partially sealed about the vacuum nozzle (24) such that the vacuum pump (23) is able to reduce the bagged pet product (26) through evacuation of air. Naturally, a complete seal of the opening is not entirely needed in some embodiments. The vacuum pump may continue to operate as the outer encasing shown in FIG. 15 is appropriated. The outer encasing (29) may be suitably sized so that it will fit over the compressed pet product (28) while being held in a reduced-volume state from the vacuum pump (23). In the preferred embodiment, the outer encasing (29) may have at least one opening element (30), such as serrations, that may assist in retrieving, locating, and later removing the outer encasing (29) from the compressed pet product (28).

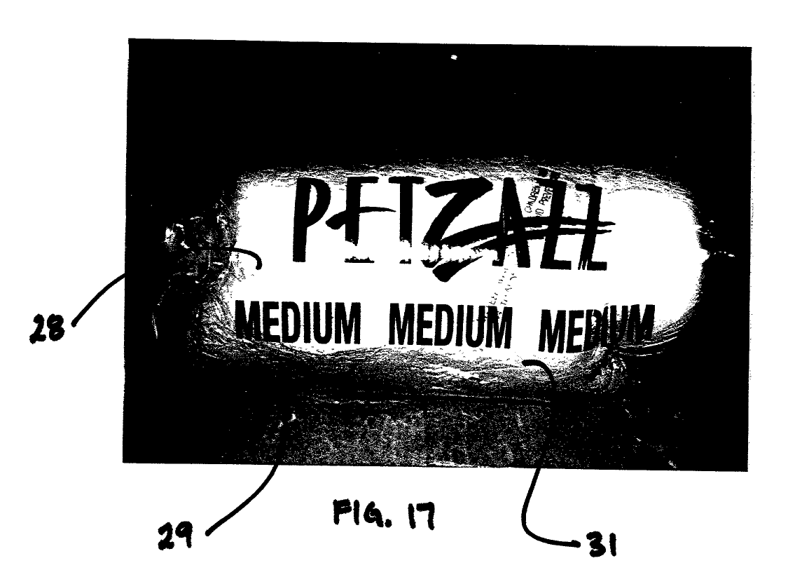

FIG. 16 shows the outer encasing (29) being inserted over a distant end of the compressed pet product (28) from the vacuum nozzle (24). In this figure, the outer encasing may be manually slipped over the compressed pet product; however, in other embodiments, the operation could be more automated.

Finally, in FIG. 17, the completed, encased, compressed pet product (31) is shown. At this point, the vacuum source has been removed and the compressed pet product typically restored to more of an ambient pressure environment by being exposed to the ambient pressure. (Exposed in this context is meant to include exposing the compressible pet product to an ambient pressure when the encasing is not sealed and thus allowing the pet product to reexpand unless held in the reduced-volume state by, for instance, an encasing.) However, the compressed pet product (28) is retained in a compressed condition by the outer encasing (29) at least partially surrounding the compressed pet product (28). Naturally, the outer encasing (29) could be made from a variety of configurations and materials. As an example the outer encasing could include a sleeve, tube, container, made from a plastic, polyethylene, cardboard, metal and other appropriate materials as the pet industry would find suitable, given commercial considerations.

As should be appreciated the various aspects of the embodiments described may be combined in different ways. Naturally compression can occur externally or through an evacuation element. This may be included with an inner wrapping or not. Further, sealing prior to compressing, or even after compressing, may or may not occur as well. Again, it is intended that the broad scope of this patent encompass all various permutations and combinations since each may be dependent on or selected for particular applications involved. The market place and manufacturing concerns may dictate the appropriate embodiments for the present invention.

The foregoing discussion and the claims that follow describe only the preferred embodiments of the present invention. Particularly with respect to the claims, it should be understood that a number of changes may be made without departing from the essence of the present invention. In this regard, it is intended that such changes—to the extent that they substantially achieve the same results in substantially the same way—will still fall within the scope of the present invention.

Although the methods related to the system are being included in various detail, only initial claims directed toward the compressed pet product, system, and method have been included. Naturally, those claims could have some application to the various other methods, systems, and apparatus claimed throughout the patent. The disclosure of the system or method context is sufficient to support the full scope of methods and apparatus claims with, for instance, an encasing whether impermeable or not, various flea retardants, various combinations of fibrous or foam materials such polyester fibers, various types of polyester fibers, heating elements, mechanical compression, various outer encasings, the use of an encasing or not, pre-compression folding, and so forth. While these may be added to explicitly include such details, the existing claims may be construed to encompass each of the other general aspects. Without limitation, the present disclosure should be construed to encompass subclaims, some of those presented in an apparatus, system or method context as described above for each of the other general aspects. In addition, to the extent any revisions utilize the essence of the invention, each would naturally fall within the breadth of protection encompassed by this patent. This is particularly true for the present invention since its basic concepts and understandings may be broadly applied.

As mentioned earlier, this invention can be embodied in a variety of ways. In addition, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all action may be expressed as a means for taking that action or as an element which causes that action. Similarly, each physical element disclosed should be understood to encompass a disclosure of the action which that physical element facilitates. Regarding this last aspect, the disclosure of a “encasing” should be understood to encompass disclosure of the act of “encasing”—whether explicitly discussed or not—and, conversely, were there only disclosure of the act of “encasing”, such a disclosure should be understood to encompass disclosure of an “encasing.” Such changes and alternative terms are to be understood to be explicitly included in the description.

It is simply not practical to describe in the claims all the possible embodiments to the present invention which may be accomplished generally in keeping with the goals and objects of the present invention and this disclosure and which may include separately or collectively such aspects as an encasing whether impermeable or not, various flea retardants, various combinations of fibrous or foam materials such polyester fibers, various types of polyester fibers, heating elements, mechanical compression, various outer encasings, the use of an encasing or not, pre-compression folding, and other aspects of the present invention. While these may be added to explicitly include such details, the existing claims should be construed to encompass such aspects. To the extent the methods claimed in the present invention are not further discussed, they are natural outgrowths of the system or apparatus claims. Therefore, separate and further discussion of the methods are deemed unnecessary as they otherwise claim steps that are implicit in the use and manufacture of the system or the apparatus claims. Furthermore, the steps are organized in a more logical fashion; however, other sequences can and do occur. Therefore, the method claims should not be construed to include only the order of the sequence and steps presented.

Furthermore, any references mentioned in the application for this patent as well as all references listed in any information disclosure originally filed with the application are hereby incorporated by reference. However, to the extent statements might be considered inconsistent with the patenting of this/these invention(s), such statements are expressly not to be considered as made by the applicant(s).

We claim:

1. A method of packaging a compressible pet product in a reduced-volume manner for shipment comprising the steps of:
a. specifically selecting a compressible pet product made of an open cell foam and which contains substantially no compressible open cell foam having a density less than 1.2 pounds per cubic foot;
b. reducing the volume of said compressible pet product; and
c. holding said compressible pet product in a reduced-volume state.

2. A method of packaging a compressible pet product in a reduced-volume manner as described in claim 1 wherein the step of specifically selecting the compressible pet product comprises the step of assembling a plurality of compressible products for single packaging.

3. A method of packaging a compressible pet product in a reduced-volume manner as described in claim 1 and further comprising the step of wrapping the compressible pet product with flexible sheet-like material prior to accomplishing the step of reducing the volume of said compressible pet product.

4. A reduced-volume package for shipment at an ambient pressure comprising:
a. a compressible pet product comprising an open cell foam and having substantially no compressible open cell foam having a density less than 1.2 pounds per cubic foot and wherein the compressible pet product is established in a reduced-volume state; and
b. an encasing which substantially surrounds the compressible pet product in its reduced-volume state.

5. A reduced-volume package as described in claim 4 wherein said compressible pet product comprises a plurality of compressible products assembled for single packaging.

6. A reduced-volume package as described in claim 4 wherein said compressible pet product has an outer boundary surface and further comprising an inner wrapping established between the compressible pet product and said encasing along a portion of said outer boundary surface.

7. A method of packaging a compressible pet product in a reduced-volume manner for shipment in an ambient pressure environment comprising the steps of:
a. providing the compressible pet product;
b. substantially surrounding the compressible pet product by a flexible encasing;
c. reducing the volume of said compressible pet product; and
d. holding said compressible pet product in a reduced-volume state through interaction between said encasing and the ambient pressure environment:

8. A method of packaging a compressible pet product in a reduced-volume manner as described in claim 7 wherein the step of providing the compressible pet product comprises the step of specifically selecting a compressible pet product made of an open cell foam and which contains substantially no compressible open cell foam having a density less than 1.2 pounds per cubic foot.

9. A method of packaging a compressible pet product in a reduced-volume manner as described in claim 1 or 8 wherein the step of reducing the volume of the compressible pet product comprises the step of externally compressing the compressible pet product after accomplishing the step of substantially surrounding the compressible pet product by the flexible encasing.

10. A method of packaging a compressible pet product in a reduced-volume manner as described in claim 1 or 8 wherein the step of reducing the volume of the compressible pet product comprises the step of lowering the pressure to which the compressible pet product is subjected after accomplishing the step of substantially surrounding the compressible pet product by the flexible encasing.

11. A method of packaging a compressible pet product in a reduced-volume manner as described in claim 1, 7, or 8 and further comprising the step of lowering the pressure to which the compressible pet product is subjected and wherein the step of reducing the volume of the compressible pet product comprises the step of exposing the encasing to the ambient pressure environment.

12. A method of packaging a compressible pet product in a reduced-volume manner as described in claim 11 and further comprising the step of sealing said encasing prior to accomplishing the step of exposing the compressible pet product to the ambient pressure environment.

13. A method of packaging a compressible pet product in a reduced-volume manner as described in claim 1 or 8 and further comprising the step of incorporating an integral opening means into the flexible encasing.

14. A method of packaging a compressible pet product in a reduced-volume manner as described in claim 13 wherein the step of incorporating an integral opening means into the flexible encasing comprises the step of integrating the opening means prior to accomplishing the step of substantially surrounding the compressible pet product by the flexible encasing.

15. A method of packaging a compressible pet product in a reduced-volume manner as described in claim 8 wherein the step of providing the compressible pet product comprises the step of assembling a plurality of compressible products for single packaging.

16. A reduced-volume package for shipment at an ambient pressure comprising:
a. a compressible pet product wherein the compressible pet product is established in a reduced-volume state;
b. a flexible encasing substantially surrounding the compressible pet product;
c. a seal to which the flexible encasing is responsive and which acts to hold the compressible pet product in its reduced-volume state through interaction between said encasing and the ambient pressure environment.

17. A reduced-volume package as described in claim 16 wherein said compressible pet product comprises an open cell foam and has substantially no compressible open cell foam having a density less than 1.2 pounds per cubic foot.

18. A reduced-volume package as described in claim 4 or 17 wherein said encasing comprises a container capable of defining a plurality of edges and having a pre-established seal along all but one of said edges.

19. A reduced-volume package as described in claim 17 wherein said compressible pet product comprises a plurality of compressible products assembled for single packaging.

20. A foam pet product package comprising:
a. a foam pet product wherein the foam pet product is established in a reduced-volume state;
b. a flexible encasing substantially surrounding the foam pet product;
c. a seal to which the flexible encasing is responsive and which acts to hold the compressible pet product in its reduced-volume state through interaction between said encasing and the ambient pressure environment.

21. A foam pet product package as described in claim 20 wherein said foam pet product comprises an open cell foam and has substantially no compressible open cell foam having a density less than 1.2 pounds per cubic foot.

22. A foam pet product package as described in claim 21 wherein said encasing comprises a container capable of defining a plurality of edges and having a pre-established seal along some of said edges.

23. A foam pet product package as described in claim 22 wherein said flexible encasing comprises an integral opening means.

24. A foam pet product package as described in claim 23 wherein said integral opening means is located along one of the edges having a pre-established seal.

25. A foam pet product package as described in claim 20 or 21 wherein said foam pet product package comprises a plurality of compressible products assembled for single packaging.

26. A method of supplying a foam pet product for use at an ambient pressure comprising the steps of:
a. providing the foam pet product;
b. substantially surrounding the foam pet product by a flexible encasing;
c. reducing the volume of said foam pet product; and
d. holding said foam pet product in a reduced-volume state through interaction between said encasing and the ambient pressure environment.

27. A method of packaging a foam pet product in a reduced-volume manner as described in claim 26 wherein the step of providing the foam pet product comprises the step of specifically selecting a compressible pet product made of an open cell foam and which contains substantially no compressible open cell foam having a density less than 1.2 pounds per cubic foot.

28. A method of supplying a foam pet product as described in claim 27 wherein said step of reducing the volume of said foam pet product comprises the step of externally compressing the foam pet product after accomplishing the step of substantially surrounding the foam pet product by the flexible encasing.

29. A method of supplying a foam pet product as described in claim 27 wherein said step of reducing the volume of said foam pet product comprises the step of lowering the pressure to which the said pet product is subjected after accomplishing the step of substantially surrounding the pet product by the flexible encasing.

30. A method of packaging a foam pet product in a reduced-volume manner as described in claim 27 and further comprising the step of lowering the pressure to which the foam pet product is subjected and wherein the step of reducing the volume of the foam pet product comprises the step of exposing the encasing to the ambient pressure environment.

31. A method of packaging a foam pet product in a reduced-volume manner as described in claim 30 and further comprising the step of sealing said encasing prior to accomplishing the step of exposing the compressible pet product to the ambient pressure environment.

32. A method of packaging a foam pet product in a reduced-volume manner as described in claim 29 wherein the step of lowering the pressure to which the foam pet product is subjected comprises the steps of:
a. placing the foam pet product and the encasing within a low pressure chamber; and
b. lowering the pressure within the low pressure chamber;
and wherein said step of sealing said encasing is accomplished within the low pressure chamber.

33. A method of supplying a foam pet product as described in claim 26 or 27 wherein said step of providing the foam pet product comprises the step of assembling a plurality of foam pet products for single packaging.

34. A method of packaging a compressible pet product in a reduced-volume manner wherein the compressible pet product is shipped in an ambient pressure environment comprising the steps of:
a. providing the compressible pet product;
b. substantially surrounding the compressible pet product by a flexible encasing;
c. lowering the pressure to which the compressible pet product is subjected;
d. sealing said encasing; and then
e. exposing the compressible pet product to the ambient pressure environment.

35. A method of packaging a compressible pet product in a reduced-volume manner as described in claim 34 wherein the step of providing the compressible pet product comprises the step of specifically selecting a compressible pet product made of an open cell foam and which contains substantially no compressible open cell foam having a density less than 1.2 pounds per cubic foot.

36. A method of packaging a compressible pet product in a reduced-volume manner as described in claim 34 or 35 wherein the step of lowering the pressure to which the compressible pet product is subjected comprises the steps of:
a. placing the compressible pet product and the encasing within a low pressure chamber; and
b. lowering the pressure within the low pressure chamber;
and wherein said step of sealing said encasing is accomplished within the low pressure chamber.

37. A method of packaging a compressible pet product in a reduced-volume manner as described in claim 36 wherein the step of sealing the encasing comprises the step of heating at least a portion of the encasing.

38. A method of packaging a compressible pet product in a reduced-volume manner as described in claim 34 or 35 and further comprising the step of incorporating an integral opening means into the flexible encasing.

39. A method of packaging a compressible pet product in a reduced-volume manner as described in claim 38 wherein the step of incorporating an integral opening means into the flexible encasing comprises the step of integrating the opening means prior to accomplishing the step of substantially surrounding the compressible pet product by the flexible encasing.

40. A method of packaging a compressible pet product in a reduced-volume manner as described in claim 34 wherein the step of providing the compressible pet product comprises the step of assembling a plurality of compressible products for single packaging.

41. A method of packaging a compressible pet product in a reduced-volume manner comprising the steps of:
a. providing the compressible pet product;
b. wrapping the compressible pet product with flexible sheet-like material;
c. substantially surrounding the compressible pet product by a flexible encasing; and
d. reducing the volume of said compressible pet product.

42. A method of packaging a compressible pet product in a reduced-volume manner as described in claim 41 wherein the step of providing the compressible pet product comprises the step of specifically selecting a compressible pet product made of an open cell foam and which contains substantially no compressible open cell foam having a density less than 1.2 pounds per cubic foot.

43. A method of packaging a compressible pet product in a reduced-volume manner as described in claim 41 wherein the compressible pet product is shipped in an ambient pressure environment and further comprising the steps of:
a. lowering the pressure to which the compressible pet product is subjected after accomplishing the step of substantially surrounding the compressible pet product by said flexible encasing; and then
b. sealing said encasing;
and wherein the step of reducing the volume of said compressible pet product comprises the step of exposing the compressible pet product to the ambient pressure environment.

44. A method of packaging a compressible pet product in a reduced-volume manner as described in claim 42 wherein the compressible pet product is shipped in an ambient pressure environment and further comprising the steps of:
a. lowering the pressure to which the compressible pet product is subjected after accomplishing the step of substantially surrounding the compressible pet product by said flexible encasing; and then
b. sealing said encasing;
and wherein the step of reducing the volume of said compressible pet product comprises the step of exposing the compressible pet product to the ambient pressure environment.

45. A method of packaging a compressible pet product in a reduced-volume manner as described in claim 41 wherein the compressible pet product is shipped in an ambient pressure environment and wherein the step of reducing the volume of said compressible pet product comprises the step of lowering the pressure to which the compressible pet product is subjected and further comprising the step of holding said compressible pet product in a reduced-volume state through interaction between said encasing and the ambient pressure environment.

46. A method of packaging a compressible pet product in a reduced-volume manner as described in claim 42 wherein the compressible pet product is shipped in an ambient pressure environment and wherein the step of reducing the volume of said compressible pet product comprises the step of lowering the pressure to which the compressible pet product is subjected and further comprising the step of holding said compressible pet product in a reduced-volume state through interaction between said encasing and the ambient pressure environment.

47. A method of packaging a compressible pet product in a reduced-volume manner as described in claim 41 wherein the step of reducing the volume of the compressible pet product comprises the step of externally compressing the compressible pet product after accomplishing the step of substantially surrounding the compressible pet product by the flexible encasing.

48. A method of packaging a compressible pet product in a reduced-volume manner as described in claim 42 wherein the step of reducing the volume of the compressible pet product comprises the step of externally compressing the compressible pet product after accomplishing the step of substantially surrounding the compressible pet product by the flexible encasing.

49. A method of packaging a compressible pet product in a reduced-volume manner as described in claim 3, 41, 42, 43, or 45 wherein the step of wrapping the compressible pet product with flexible sheet-like material comprises the step of encircling said compressible pet product with a material which exhibits low friction with respect to said encasing.

50. A method of packaging a compressible pet product in a reduced-volume manner as described in claim 3 or 41 wherein the step of wrapping the compressible pet product with flexible sheet-like material comprises the step of encircling said compressible pet product with a material which exhibits high friction with respect to itself.

51. A method of packaging a compressible pet product in a reduced-volume manner as described in claim 42 wherein the step of wrapping the compressible pet product with flexible sheet-like material comprises the step of encircling said compressible pet product with a material which exhibits high friction with respect to itself.

52. A method of packaging a compressible pet product in a reduced-volume manner as described in claim 49 wherein the step of wrapping the compressible pet product with flexible sheet-like material comprises the step of encircling said compressible pet product with a material which exhibits high friction with respect to itself

53. A method of packaging a compressible pet product in a reduced-volume manner as described in claim 3 or 42 wherein the step of wrapping the compressible pet product with flexible sheet-like material comprises the step of initially compressing the compressible pet product.

54. A method of packaging a compressible pet product in a reduced-volume manner as described in claim 53 wherein the step of initially compressing the compressible pet product comprises the step of making the compressible pet product more spherical.

55. A method of packaging a compressible pet product in a reduced-volume manner as described in claim 54 wherein the step of substantially surrounding the compressible pet product by a flexible encasing comprises the step of inserting the compressible pet product into a bag which has been sized to accommodate not substantially more than the initially compressed pet product after the step of initially compressing the compressible pet product.

56. A method of packaging a compressible pet product in a reduced-volume manner as described in claim 42 further comprising the step of incorporating an integral opening means into the flexible encasing.

57. A method of packaging a compressible pet product in a reduced-volume manner as described in claim 56 wherein the step of incorporating an integral opening means into the flexible encasing comprises the step of integrating the opening means prior to accomplishing the step of substantially surrounding the compressible pet product by the flexible encasing.

58. A method of packaging a compressible pet product in a reduced-volume manner as described in claim 41 wherein the step of providing the compressible pet product comprises the step of assembling a plurality of compressible products for single packaging.

59. A reduced-volume package for shipment at an ambient pressure comprising:
a. a compressible pet product wherein the compressible pet product is established in a reduced-volume state and has an outer boundary surface;
b. a flexible encasing substantially surrounding the compressible pet product throughout said outer boundary; and
c. an inner wrapping established between the compressible pet product and the flexible encasing along a portion of said outer boundary.

60. A reduced-volume package as described in claim 59 wherein said compressible pet product comprises an open cell foam and has substantially no compressible open cell foam having a density less than 1.2 pounds per cubic foot.

61. A reduced-volume package as described in claim 6, 59, or 60 wherein said inner wrapping comprises a material which exhibits low friction with respect to said encasing.

62. A reduced-volume package as described in claim 6, 59, or 60 wherein said inner wrapping comprises a material which exhibits high friction with respect to itself.

63. A reduced-volume package as described in claim 61 wherein said inner wrapping further comprises a material which exhibits high friction with respect to itself.

64. A reduced-volume package as described in claim 59 or 60 wherein said encasing comprises an integral opening means.

65. A reduced-volume package as described in claim 64 wherein said integral opening means is located along one of the edges having a pre-established seal.

66. A reduced-volume package as described in claim 59 wherein said compressible pet product comprises a plurality of compressible products assembled for single packaging.

67. A method of packaging a compressible pet product in a reduced-volume manner comprising the steps of:
a. providing the compressible pet product;
b. initially compressing the compressible pet product;
c. substantially surrounding the compressible pet product in its initially compressed state by a flexible encasing;
d. reducing the volume of said compressible pet product to create a fully compressed state; and
e. holding said compressible pet product in its fully compressed state.

68. A method of packaging a compressible pet product in a reduced-volume manner as described in claim 67 wherein the step of initially compressing the compressible pet product comprises the step of making the compressible pet product more spherical.

69. A method of packaging a compressible pet product in a reduced-volume manner as described in claim 68 wherein the step of making the compressible pet product more spherical comprises the step of folding said compressible pet product.

70. A method of packaging a compressible pet product in a reduced-volume manner as described in claim 68 wherein the step of reducing the volume of the compressible pet product to create a fully compressed state comprises the steps of:
a. lowering the pressure to which the compressible pet product is subjected after accomplishing the step of substantially surrounding the compressible pet product by said flexible encasing; and then
b. sealing said encasing;
and wherein the step of reducing the volume of said compressible pet product comprises the step of exposing the compressible pet product to the ambient pressure environment.

71. A method of packaging a compressible pet product in a reduced-volume manner as described in claim 68 wherein the compressible pet product is shipped in an ambient pressure environment and wherein the step of reducing the volume of the compressible pet product comprises the step of lowering the pressure to which the compressible pet product is subjected after accomplishing the step of substantially surrounding the compressible pet product by said flexible encasing and wherein the step of holding said compressible pet product in its fully compressed state comprises holding said compressible pet product in a reduced-volume state through interaction between said encasing and the ambient pressure environment.

72. A method of packaging a compressible pet product in a reduced-volume manner as described in claim 68 or 70 and further comprising the step of inserting the compressible pet product into a bag which has been sized to accommodate not substantially more than the initially compressed pet product after the step of initially compressing the compressible pet product.

73. A method of packaging a compressible pet product in a reduced-volume manner as described in claim 72 and further comprising the step of incorporating an integral opening means into the flexible encasing.

74. A method of packaging a compressible pet product in a reduced-volume manner as described in claim 73 wherein the step of incorporating an integral opening means into the flexible encasing comprises the step of integrating the opening means prior to accomplishing the step of substantially surrounding the compressible pet product by the flexible encasing.

75. A method of packaging a compressible pet product in a reduced-volume manner as described in claim 73 wherein the step of initially compressing the compressible pet product comprises the step of making the compressible pet product more spherical.

76. A reduced-volume package as described in claim 16 wherein said compressible pet product is folded and has been further established in a reduced-volume state.

77. A reduced-volume package as described in claim 76 wherein said compressible pet product comprises an open cell foam and has substantially no compressible open cell foam having a density less than 1.2 pounds per cubic foot.

78. A reduced-volume package as described in claim 77 wherein said compressible pet product is folded wherein said flexible encasing comprises a bag which has been sized to accommodate not substantially more than the folded compressed pet product.

79. A reduced-volume package as described in claim 77 or 78 wherein said flexible encasing comprises an integral opening means.

80. A reduced-volume package as described in claim 79 wherein said integral opening means is located along one of the edges having a pre-established seal.

81. A reduced-volume compressed pet product package as described in claim 4 wherein said encasing comprises an evacuation encasing and wherein said evacuation encasing is substantially impermeable and further comprising a seal to which said evacuation encasing is responsive and which is adapted to hold said compressible pet product in its reduced-volume state through an interaction between said impermeable evacuation encasing and said ambient pressure.

82. A reduced-volume compressed pet product package as described in claim 81 wherein said compressible pet product comprises primarily fibrous material.

83. A reduced-volume compressed pet product package as described in claim 82 wherein said fibrous material comprises primarily polyester fiber material.

84. A reduced-volume compressed pet product package as described in claim 83 wherein said polyester fiber material comprises primarily solid fibers.

85. A reduced-volume compressed pet product package as described in claim 83 wherein said polyester fiber material comprises primarily hollow fibers.

86. A reduced-volume compressed pet product package as described in claim 83 wherein said polyester fiber material comprises primarily bent fibers.

87. A reduced-volume compressed pet product package as described in claim 82 wherein said fibrous material further comprises cedar chips.

88. A reduced-volume compressed pet product package as described in claim 4 wherein said encasing comprises an outer encasing and wherein said outer encasing is adapted to structurally hold said compressible pet product in said reduced-volume state independent of any difference in pressure between said ambient pressure and a pressure of said pet product in said reduced-volume state.

89. A reduced-volume compressed pet product package as described in claim 88 further comprising an evacuation encasing adapted to at least temporarily enable said pet product to be held in said reduced-volume state while said outer encasing is placed on said compressible pet product in said reduced-volume state.

90. A reduced-volume compressed pet product package as described in claim 4 wherein said encasing further comprises at least one opening element adapted to assist in removal of said encasing.

91. A reduced-volume compressed pet product package as described in claim 4 wherein said compressible pet product comprises a plurality of products.

92. A reduced-volume compressed pet product package as described in claim 4 wherein said compressible pet product comprises primarily foam material.

93. A reduced-volume compressed pet product package as described in claim 4 wherein said compressible pet product comprises at least a partially pre-compression folded pet product.

94. A reduced-volume compressed pet product package as described in claim 4 wherein said compressible pet product comprises a portion of flea retardant.

95. A reduced-volume compressed pet product package as described in claim 4 wherein said compressible pet product comprises a portion of fire retardant.

96. A reduced-volume compressed pet product package as described in claim 4 wherein said compressible pet product comprises a portion of cedar chips.

97. A reduced-volume compressed pet product package as described in claim 4 wherein said pet product package is color-coded.

98. A reduced-volume compressed pet product system for shipment of said reduced-volume pet product in an ambient pressure environment comprising:
a. a compressible pet product;
b. a compression element adapted to establish said compressible pet product in a substantially reduced-volume state;
b. an encasing which at least partially surrounds said compressible pet product in its reduced-volume state
wherein said encasing is adapted to allow said compressible pet product to be shipped in said reduced-volume state in said ambient pressure environment.

99. A reduced-volume compressed pet product system as described in claim 98 wherein said compression element further comprises a vacuum pump and a vacuum nozzle wherein said vacuum nozzle is of sufficient length to be inserted into a volume of said compressible pet product and wherein said vacuum nozzle comprises a plurality of vacuum holes adapted to assist in evacuating air from said compressible pet product.

100. A reduced-volume compressed pet product system as described in claim 98 wherein said compressible pet product comprises primarily a polyester fiber pet product and further comprising a heating element adapted to restore resiliency of said polyester fiber pet product after said pet product is held for a time is said reduced-volume state.

101. A reduced-volume compressed pet product system as described in claim 99 wherein said encasing comprises an evacuation encasing and wherein said evacuation encasing is substantially impermeable and further comprising a seal to which said evacuation encasing is responsive and which is adapted to hold said compressible pet product in its reduced-volume state through an interaction between said impermeable evacuation encasing and said ambient pressure environment.

102. A reduced-volume compressed pet product system as described in claim 98 wherein said compressible pet product comprises a folded pet product prior to said reduced-volume state.

103. A method of packaging a compressible pet product in a reduced-volume manner as described in claim 34 wherein compressing said pet product comprises encasing said compressible pet product prior to compressing said pet product, evacuating at least a portion of fluid from said pet product, sealing said compressible pet product from ambient pressure, releasing said compressible pet product, and allowing compression from an externally greater ambient pressure.

104. A method of packaging a compressible pet product in a reduced-volume manner as described in claim 34 wherein providing a compressible pet product comprises utilizing fibrous material.

105. A method of packaging a compressible pet product in a reduced-volume manner as described in claim 104 wherein utilizing fibrous material comprises utilizing polyester fiber material.

106. A method of packaging a compressible pet product in a reduced-volume manner as described in claim 105 further comprising heating said polyester fiber material to restore resiliency after said polyester fiber material has been compressed for a time.

107. A method of packaging a compressible pet product in a reduced-volume manner as described in claim 34 further comprising including cedar chips with said compressible pet product prior to compressing said pet product.

108. A method of packaging a compressible pet product in a reduced-volume manner as described in claim 34 further comprising including a flea retardant with said compressible pet product prior to compressing said pet product.

109. A method of packaging a compressible pet product in a reduced-volume manner as described in claim 34 further comprising color-coding said compressible pet product.

110. A method of packaging a compressible pet product in a reduced-volume manner as described in claim 34 further comprising folding said compressible pet product prior to compressing said pet product.

111. A method of packaging a compressible pet product in a reduced-volume manner as described in claim 34 further comprising encasing said compressible pet product in an outer encasing while holding said pet product in a reduced-volume state and before exposing said compressible pet product to said ambient pressure environment and further comprising at least partially exposing internal surfaces of said compressed pet product to said ambient pressure environment while continuing to hold said pet product in said reduced-volume state with said encasing.

112. A method of packaging a compressible pet product in a reduced-volume manner as described in claim 111 further comprising encasing said compressible pet product in an evacuation encasing prior to encasing said pet product in said outer encasing, associating said pet product and said evacuation encasing to a compression element, evacuating at least a portion of fluid from said pet product encased by said evacuation encasing by utilizing said compression element, and then while holding said pet product in said reduced-volume state occurs, at least partially encasing said pet product with said outer encasing prior to exposing said compressible pet product to said ambient pressure environment wherein exposing said compressible pet product comprises exposing at least some inside surfaces of said pet product to said ambient pressure environment.

113. A method of packaging a compressible pet product in a reduced-volume manner as described in claim 111 further comprising utilizing a heating element to heat said compressible pet product and restoring at least partially a resiliency of said compressible pet product.

114. A method of packaging a compressible pet product in a reduced-volume manner as described in claim 111 wherein encasing said compressible pet product comprises pressing said compressible pet product in said reduced-volume state into said an outer encasing.
